(19) United States
(12) Patent Application Publication
(10) Pub. No.: US 2015/0000493 A1
(43) Pub. Date: Jan. 1, 2015

(54) TABLE SAW TRAVERSING MECHANISM

(71) Applicants: Mark Fianza Boseman, Suffolk, VA (US); John Fianza Boseman, Suffolk, VA (US)

(72) Inventors: Mark Fianza Boseman, Suffolk, VA (US); John Fianza Boseman, Suffolk, VA (US)

(21) Appl. No.: 13/931,865

(22) Filed: Jun. 29, 2013

(51) Int. Cl. B27B 5/20; B27B 5/18

(52) U.S. Cl. CPC B27B 5/202; B27B 5/181
USPC 83/473

(57) ABSTRACT

A table saw including a horizontally disposed table surface with an elongated blade slot, mounted beneath the table surface is a traversing mechanism comprising a carriage coupled to linear guide rails and linear actuator to movably advance and retreat the carriage supporting the blade in a traversing path generally parallel to the blade slot. A tilt plate pivotally mounted to the carriage supports a blade drive assembly for providing a means to rotate the blade and adjust the blade height. The saw blade protrudes through the elongated slot to cut a work-piece on the table surface whereby stationary and moving work-piece operations may be executed. A tilting mechanism, also supported by the carriage, having a linear actuator in a translating engagement with the tilt plate rotate the tilt plate about its pivot axis relative to the carriage to set the blade to the angle desired by the user for beveled cuts. Blade height, angle and traversing speed are electronically controlled and set by the user through a user interface panel.

### BACKGROUND

### Prior Art

The following is a tabulation of some prior art that presently appears relevant:

### U.S. Patents

| | Kind | | |
|---|---|---|---|
| Patent Number | Code | Issue Date | Patentee |
| 3,344,819 | A | 1967 Oct. 3 | Mitchell |
| 7,721,633 | B2 | 2010 May 25 | Gaw |
| 4,209,045 | A | 1981 Oct. 6 | Walker |

### Foreign Patent Documents

| | Kind | | |
|---|---|---|---|
| Foreign Doc. Nr. | Code | Pub. Dt | App or Patentee |
| 1116539 | A3 | 2003 Nov. 12 | Sberveglieri |

A table saw is a power tool commonly used to facilitate forming a work-piece to a desired shape. To shape or cut the work-piece, a circular saw blade exposed above the table surface is rotated at a fixed point while the work-piece is slid on the table surface towards the blade. All table saws present a safety concern because saw blades are inherently sharp by design and rotate at a high rate of speed. Accordingly, injury such as severed digits and deep lacerations can occur almost instantaneously. In response to the dangers inherent with an exposed blade moving at high speed, a number of safety systems have been developed. One such safety system is a blade guard. Blade guards movably enclose the saw blade, thereby providing a physical barrier that must be moved before the rotating blade is exposed. While blade guards are effective in preventing injuries they can be removed for better convenience of use or removed because the blade guard is not compatible for use with a particular shaping device. For example, a blade guard is typically not compatible with a dado blade and must typically be removed when performing non-through cuts.

Table saw safety systems have also been developed which are intended to stop the blade when a user's hand or fingers touches the blade. This type of safety feature is commonly employed thru braking devices that are physically inserted into the teeth of the blade. Upon actuation of this type of braking device, however, the blade and breaking member are typically ruined and for each time the safety device is actuated, significant resources must be expended to replace the blade and the braking member. Moreover, if spare blade and braking member are not on hand, a user must travel to a store to obtain replacements. Another shortcoming of this type of safety device is that, without having to damage the blade and braking member, the user has no means of testing whether the electronic controls responsible for stopping the blade are properly functioning. Defects in manufacturing and quality control failures are always a possibility and in the event the electronic controls are defective, the user will have no way of knowing whether the safety feature is functioning. This could lead to a fake sense of security that might perpetuate increased risk taking on part of the user and thus, increase the risk of injury. A further disadvantage of such a system is that the shaping device must be toothed and the safety system is prone to actuate when the material being cut is damp or wet. As such, wet or damp materials must be dried first before cutting, otherwise the user risks the chance of the safety system actuating and causing the needles expense of replacing the blade and the braking member. Thus, while effective, this type of safety system can be expensive, inconvenient and uncertain.

Other devices commonly called jigs have also been developed in a variety of configurations to again reduce the possibility of having a hand or finger contact the blade. The various jig configurations generally enhance the operator's safety by increasing the distance of the user's hand away from the blade while making a cut. Although the risk to the user is reduced, the user must still assume a considerable amount of risk, such as the slip of the hand while holding and sliding the jig in relative close proximity to the blade. Another shortcoming of such systems is that they are typically designed for a specific cut. For example, a tenoning jig is only useful for making tenons. Since table saws are commonly used to cut various materials in a variety of ways, the user will have to expend resources for each kind of cut that can be more safely accomplished by use of a jig.

Table saws are also currently configured with manual blade height and angle mechanisms, where the operator must turn a handle to adjust the blade height or angle, also called bevel. Although the height and angle of the blade can be set by slowly turning the handle and carefully aligning needle and tick mark height and angle indicators, setting the height and angle of the blade by this method is prone to inaccuracies because needle and tick mark indicators are susceptible to being thrown out of calibration and because accuracy depends on the user's ability to align the needle and tick mark using the naked eye. To achieve blade height and angle precision, manual measurement of the blade height and angle with a machinist's rule and protractor is typically required. This process often necessitates touching and manually rotating the sharp blade to make an accurate measurement. Although the blade is not rotating at a high rate of speed, the sharp blade can still be a safety concern for the user who will have to physically contact the blade to make the necessary blade height or angle measurements. Moreover, while manually adjusting the blade height and angle in this manner is effective, it is inconvenient because the user must crouch at an awkward position to align his or her eyes to the measuring device and blade while turning the blade height or angle adjustment handle.

Other saw designs such as radial arm saws and slide miter saws have also been developed to provide stationary cutting from above the working platform. However, the rip cut (longitudinal cuts) widths are limited by the blades range of motion and they do not provide moving work-piece cutting capabilities. Furthermore, because the blade is mounted above the working platform, the height of the material that can be cut is limited by the space between the working platform and the blade's supporting mechanism.

In view of the foregoing, it would be advantageous to enhance user safety and convenience by providing the user with a means of making a cut without having the user physically hold and slide the work-piece and without the height limitations inherent in radial arm saw and slide miter saw designs. It would be advantageous to simply clamp the work-piece onto the table surface and have the blade traverse towards the work-piece to make the cut by the simple press of a user interface button or screen. In addition to the stationary work-piece cutting capability just described above, it would be advantageous to be able to also provide the user with a moving work-piece cutting capability. This can be especially useful when conducting rip cuts. For example, a user conducting rip cuts can set the blade in a stationary mode and slide the work-piece towards the blade, but before the user's hand approaches the blade at an unsafe distance, the user can clamp the work-piece, move his/her hands away, adjust the table saw setting via a user interface panel and traverse the blade to complete the cut. It would also be advantageous to adjust the height and angle of the table saw blade by simply entering the desired height and or angle into the user interface panel to automatically and precisely adjust the blade to the desired height or angle via an electronic controls.

### SUMMARY

In order to overcome the deficiencies noted above, the present table saw with an automated traversing mechanism has been devised. The object of the embodiment is to improve upon known prior art by enhancing user safety, convenience, and work-piece cutting capability by providing the user with an automated means of traversing the blade via electronic controls for conducting stationary work-piece operations as well as moving work-piece operations without the work-piece height limitations of radial and slide miter saw designs. It is also the object of the embodiment to provide the user a convenient means of accurately adjusting the height, angle, and traversing speed of the blade through electronic controls via a user interface panel. As will be more fully described herein, the present saw comprises a horizontally disposed working platform with an elongated blade slot coupled to a main frame and a support frame, a traversing mechanism comprising a carriage coupled to linear guide rails and movable along a traversing path parallel to the blade slot. The carriage mounted beneath the working platform is coupled to a saw blade that protrudes through the slot to cut work-pieces on the platform. Linear actuators operatively coupled to the carriage advance and retreat the carriage along the guide rails at a plurality of positions. Pivotally mounted to the carriage is a tilt plate that supports a blade drive assembly where the blade is mounted and provides a means to rotate the blade wheel and adjust the height of the blade wheel relative to the table surface. The table saw further includes a tilting mechanism used to rotate the tilt plate and the mounted blade drive assembly at an angle desired by the user. Whereby the tilting mechanism supported by the carriage contains a linear actuator in a translating engagement with the tilt plate rotate the tilt plate about its pivot axis relative to the carriage.

### DRAWINGS

### Figures

The foregoing aspects and many of the attendant advantages of this invention will become better understood by reference to the following detailed description, when taken in conjunction with the accompanying drawings, wherein:

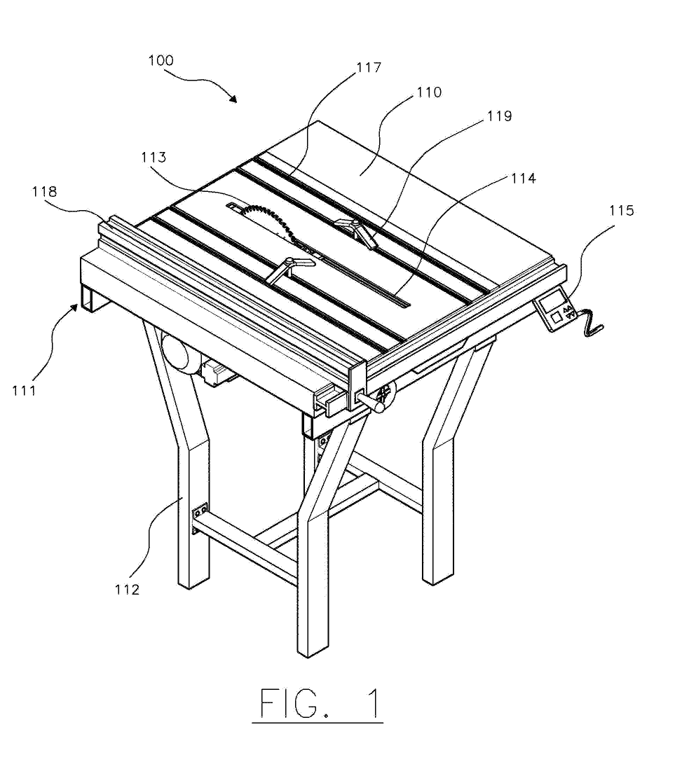

FIG. 1 is an isometric view of a table saw with a traversing blade constructed in accordance with one embodiment of the present disclosure;

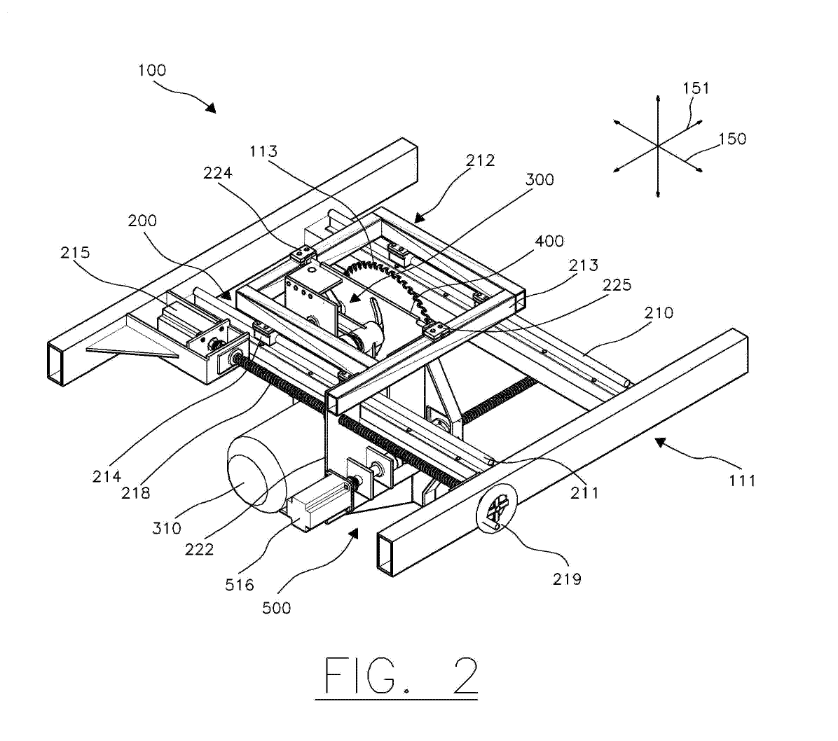

FIG. 2 is an isometric view of one suitable embodiment of the traversing mechanism, blade driving mechanism, and tilting mechanism of the table saw shown in FIG. 1;

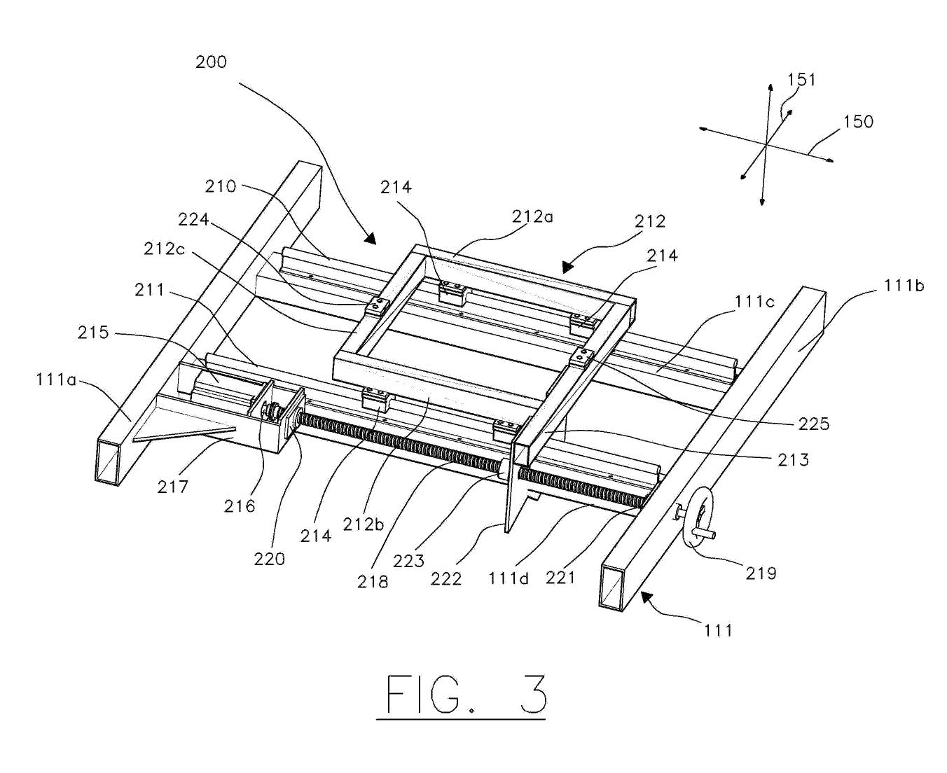

FIG. 3 is a perspective view of one suitable embodiment of a traversing mechanism of the table saw shown in FIG. 1;

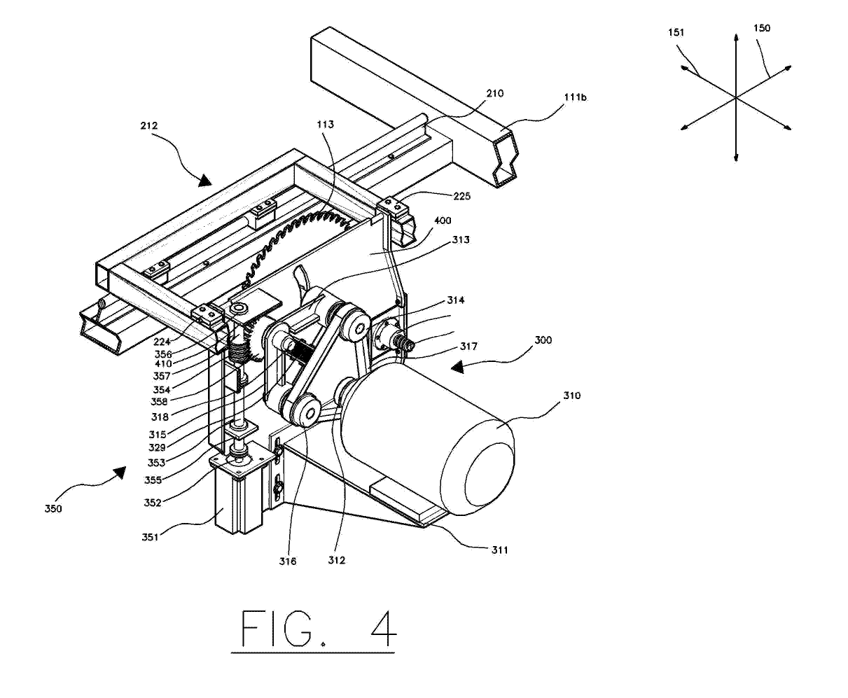

FIG. 4 is a partial isometric view of one embodiment of the blade drive assembly incorporated in the traversing mechanism of the table saw shown in FIG. 1;

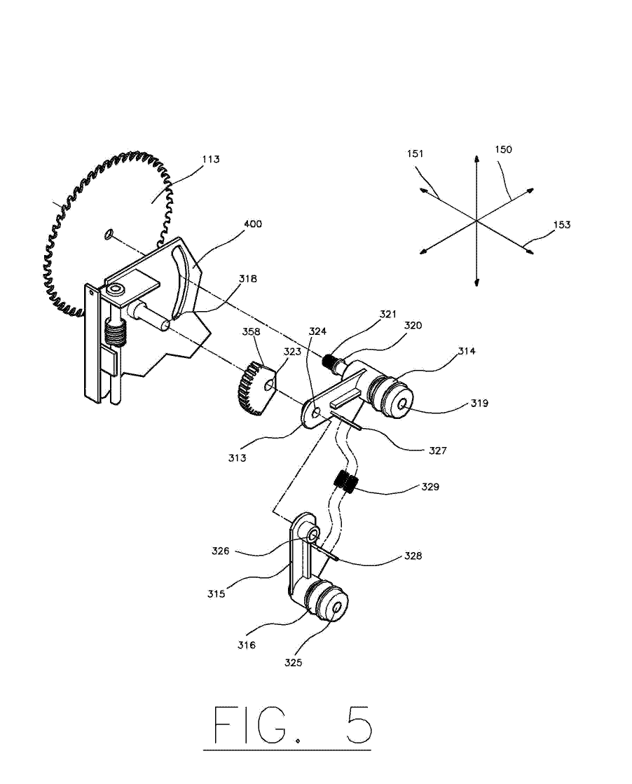

FIG. 5 is a so-called exploded view of the blade arm and counter arm of the blade drive assembly shown in FIG. 4;

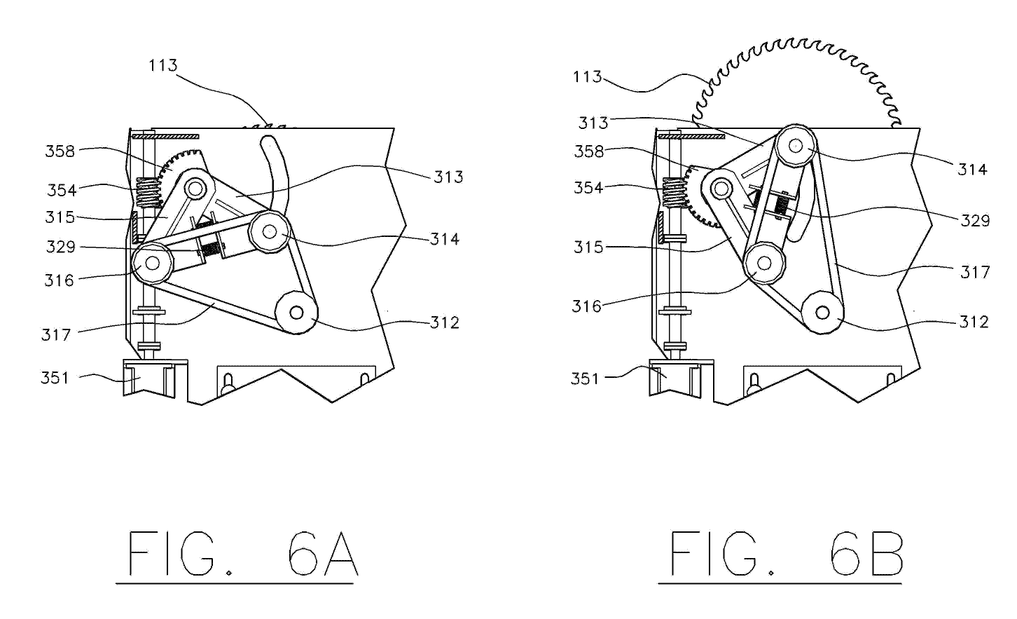

FIG. 6A is a partial side view of one suitable embodiment of the blade arm and counter arm configuration, wherein the blade wheel is in the lowered position;

FIG. 6B is a partial side view of one suitable embodiment of the blade arm and counter arm configuration, wherein the blade wheel is raised to its maximum height;

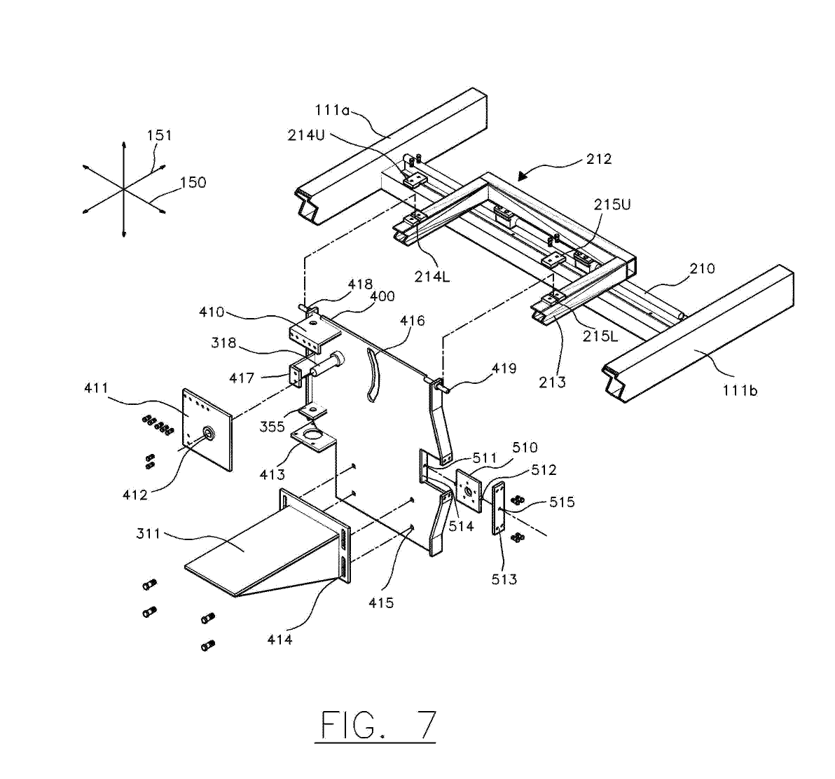

FIG. 7 is a so-called exploded view of the tilt frame and its attached elements that supports the mounting of the blade driving mechanism and tilting mechanism;

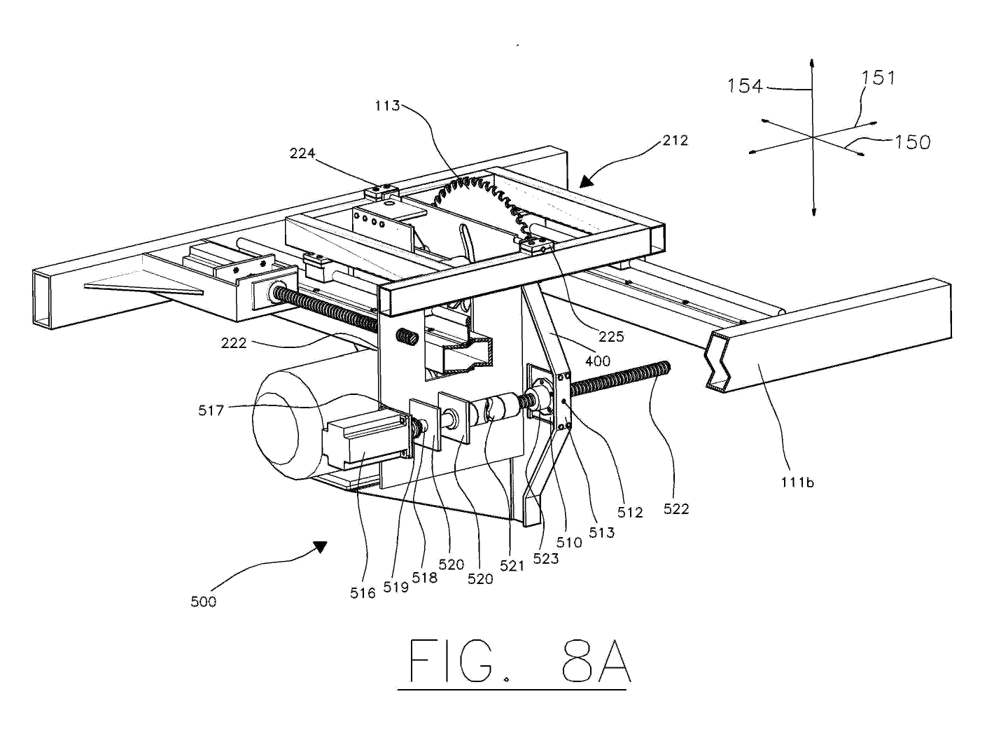

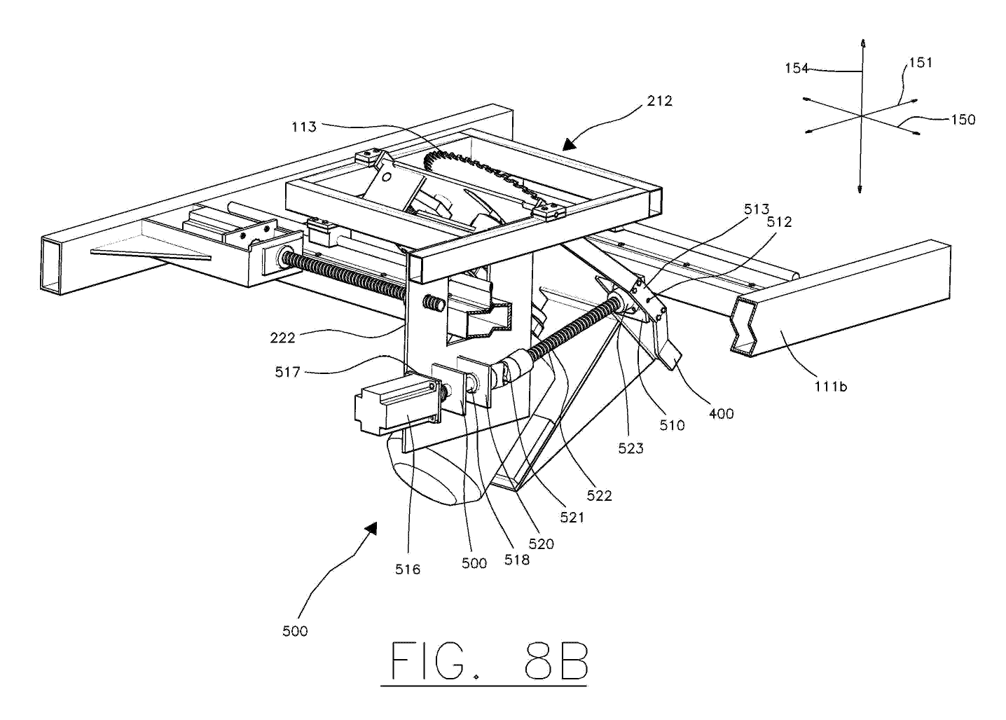

FIG. 8A is a partial perspective view of the tilting mechanism of the table saw shown in FIG. 1, wherein the tilt frame is in its nominal operating position;

FIG. 8B is a partial perspective view of the tilting mechanism of the table saw shown in FIG. 1, wherein the tilt frame is in an angled position;

### DESCRIPTION OF THE INVENTION

FIG. 1 illustrates one suitable embodiment of a table saw 100 constructed in accordance with aspects of the present disclosure. The table saw 100 has a work-piece support platform 110, a main frame assembly 111 adapted to support the work-piece support platform 110, a plurality of support legs 112 adapted to support the main frame 111, and a blade wheel 113. The blade wheel 113 is translatable to a plurality of raised positions in the vertical direction relative to the work-piece support platform 110 and traversable to a plurality of positions in the horizontal direction generally parallel to the work-piece support platform 110 along a slotted hole 114. A control panel 115 enables an operator to control the vertical, horizontal, and angular translations of the blade wheel 113 relative to the work-piece support platform 110. The control panel 115 is mounted on the main frame assembly 111 and can easily be attached and detached, so that the user can operated the blade movements anywhere around the table saw 100.

To site some of the advantages of the table saw 100 compared to a typical table saw that has a blade wheel rotating in a substantially stationary axis in the horizontal direction, as an example, when cutting generally small work-pieces where there is limited work-piece body to firmly hold and slide the work-piece safely by hand towards the rotating blade wheel 113, the user of the table saw 100 can secure the work-piece on the work-piece support platform 110 by any suitable means or using accessories that are typically available for table saws such as hold down clamps 119, which can be anchored and positioned along track 117. Once the work-piece is positioned and secured as desired by the user, the user can traverse the blade wheel 113 using the control panel 115 to make the desired cut. In this manner, a user can perform cuts on generally small work-pieces without bringing their hands in close proximity to the rotating blade wheel 113. Thus, the risk of injury is greatly reduced. Another example is when the user is nearing the end of a cut where the user is running out of sufficient work-piece body to firmly hold and continue feeding the work-piece safely, once the work-piece is within the traversing path of the blade wheel 113, the user can once again secure the work-piece as described above and finish the cut by traversing the blade wheel 113 with the control panel 115.

The components of the table saw 100 that drives the blade wheel 113 to rotate and provide the means to translate the blade wheel 113 in the horizontal, vertical, and angular directions are disposed under the work-piece support platform 110. To that end, please refer now to FIG. 2 where the table saw 100 is shown with the work-piece support platform 110 and support legs 112 removed. The table saw 100 comprises a traversing mechanism 200 for translating the blade wheel in the lateral direction 150, a blade driving mechanism 300 used to rotate the blade wheel 113, a height adjusting device 350 (see FIG. 4) for vertically translating the blade wheel 113 relative to the work-piece support platform 110, a tilt frame 400 for supporting various parts of the blade driving mechanism 300 and height adjusting device 350, and a tilting mechanism 500 for angularly positioning the blade wheel 113 relative to the work-piece support platform 110.

Referring now to FIG. 3, the figure illustrates the assembly of the traversing mechanism 200 (blade driving mechanism 300, tilt frame 400, and tilting mechanism 500 are not shown for the purpose of clarity). The main frame assembly 111 is composed of longitudinal members 111a, 111b that extend in the longitudinal direction 151 and lateral members 111c, 111d that extend in the lateral direction 150. The longitudinal members 111a and 111b are spaced apart in the lateral direction 150 and the lateral members 111c and 111d are spaced apart in the longitudinal direction 151. The lateral members 111c and 111d are fixedly attached by fasteners, welding or any other suitable means to the longitudinal members 111a and 111b.

The main frame lateral members 111c and 111d form the bases of the linear guide rails 210 and 211 for the traversing mechanism 200. The linear guide rails 210 and 211 are rigidly attached to the main frame lateral members 111c and 111d, respectively, and are configured generally parallel to the lateral direction 150.

The traversing mechanism 200 further includes a carriage assembly 212 slidably coupled to the linear guide rails 210 and 211 via a plurality of linear bearings 214, a traversing motor 215 mounted to a traversing motor mounting frame 217 that is fixedly attached to the main frame longitudinal member 111a, a traversing threaded rod 218 coupled to a traversing motor output shaft 216 on one of its ends and coupled to a traversing hand wheel 219 on its other end, shaft mount bearings 220 and 221 for supporting the traversing threaded rod 218, a vertical support plate 222 attached to a carriage extended member 213, and a traversing nut 223 fastened to the vertical support plate 222 and threadably engaged with the traversing threaded rod 218.

The carriage assembly 212 is composed of a longitudinal member 212c and extended member 213 that extend in the longitudinal direction 151 and lateral members 212a and 212b that extend in the lateral direction 150. The main frame assembly 111 and the carriage assembly 212 are configured and sized to allow the tilt frame 400 (see FIG. 4) and its attached assemblies to translate laterally and angularly without coming into contact with the main frame assembly 111 in its predetermined range of motion.

Also, as shown best in FIG. 3, the ends of the guide rails 210 and 211 terminates to a point before it reaches the main frame longitudinal members 111a and 111b to provide enough spacein between the ends of the guide rails 210, 211 and the main frame longitudinal members 111a, 111b to facilitate installation or replacement of linear bearings 214.

In operation, the traversing motor 215 rotates the traversing threaded rod 218, which in turn, moves the traversing nut 223. The traversing motor 215 is selectively reversible so that the traversing threaded rod 218 can be rotated in either direction, thereby allowing the traversing nut 223 to transmit an actuating force on the vertical support plate 222, that is attached to the carriage extended member 213, to advance and retreat the carriage assembly 212 to a plurality of positions along the linear guide rails 210 and 211. Alternatively, the traversing hand wheel 219 can be used to rotate the traversing threaded rod 218 to move the carriage assembly 212, as the user desires. The traversing threaded rod 218 and traversing nut 223 acts like a jack screw, thereby, when the traversing motor 215 is in stop, it holds the carriage assembly 212 firmly in position.

The linear actuator for traversing the carriage assembly 212 is shown as a threaded rod linear actuator and a nut. While the linear actuator is shown as threaded rod linear actuator, it may be any type of closed length linear actuator that can be attached to frame assembly 111 at both ends and can allow the carriage assembly 212 to translate linearly, including, for example, nut and screw, acme threaded rod, linear ball screw, linear track, rack and pinion, or linear slide. The traversing mechanism 200 may include two linear actuators of the same type, or each actuator may be of a different type.

Referring now to FIG. 4, to show the reader how the traversing mechanism 200 is integrated in a table saw, a compactly arranged blade driving mechanism 300 mounted on the carriage assembly 212 is shown. The blade driving mechanism 300 is mounted to the tilt frame 400 as seen from another direction. The blade driving mechanism 300 includes a blade driving motor 310 mounted to the tilt frame 400 via a blade drive motor mounting base 311, a drive pulley 312 mounted to the blade driving motor output shaft, a blade arm 313 supporting a blade pulley 314, a counter arm 315 supporting a counter pulley 316, and a drive belt 317 wound around the drive pulley 312, the blade pulley 314, and the counter pulley 316.

The blade height adjusting device 350 is used to translate the blade wheel 113 from a stowed position to a plurality of raised positions relative to the work-piece support platform 110 (see FIG. 1). The blade height adjusting device 350 includes a height adjusting motor 351, an intermediate shaft 353 coupled to the height adjusting motor output shaft 352, a worm 354 operatively coupled to the height adjusting motor output shaft 352 via the intermediate shaft 353, a shaft mount 355 for supporting the intermediate shaft 353, a shaft mount 356 integrated to the bracket 410 for supporting one end of the worm shaft 357, and a worm gear 358 fixedly attached to the blade arm 313 and engaged with the worm 354.

Accordingly, the reader will see that the carriage assembly 212 is the framework that supports the tilt frame 400, which the blade driving mechanism 300 and the height adjusting device 350 are mounted to. The tilt plate 400 is pivotably mounted to the carriage via pivot blocks 224 and 225 and pivot about an axis generally parallel to the guide rails 210 and 211.

In accordance with the aspects of the present disclosure, the blade arm 313 and counter arm 315 are configured to ensure a sufficient wrap-around frictional engagement of the drive belt 317 to the pulleys when adjusting the height of the blade wheel 113 between a raised position and a stowed position. To that end, please refer to FIG. 5 where the configuration of the blade arm 313 and counter arm 315 will be described in greater detail. As best shown in FIG. 5, the blade arm 313 includes a blade shaft 319 rotationally coupled to the blade arm 313. The blade pulley 314 is coupled to the non-threaded end of the blade shaft 319. The blade shaft 319 includes a collar 320 integrated to the blade shaft 319 to axially retain the blade wheel 113 from moving in the longitudinal direction 153 and has a threaded end 321 sized to threadably receive a blade wheel nut (not shown) to retain the blade wheel 113 from moving in the longitudinal direction 151. When the worm gear 358 is attached to the blade arm 313, the hole 323 of the worm gear 358 coaxially aligns with the hole 324 of the blade arm 313. The blade arm 313 and worm gear 358 are coaxially mounted to the axle 318 and pivot about an axis generally perpendicular to the face of the tilt frame 400.

The counter arm 315 includes a counter pulley shaft 325 rotationally coupled thereto and a counter pulley 316 is fastened to the counter arm shaft 325. The counter arm 315 has a hole 326 sized to axially fit the axle 318 and cooperatively pivot with the blade arm 313.

The blade arm 313 has a lip 327 that extends from a vertical face of the blade arm 313. The lip 327 is oriented in a generally diagonal direction. Similar to the blade arm 313, the counter arm 315 also has a lip 328 and oriented in the same manner. The lip 327 and lip 328 face each other and are sized and spaced to receive springs 329 to bias the blade arm 313 and counter arm 315, in an opposing manner, causing the blade arm 313 to apply a compressive force against the counter arm 315. Each spring 329 is fastened to lip 327 on one end and fastened to lip 328 on its other end, preferably by fasteners. As shown best in FIG. 4, the blade arm 313 and counter arm 315 forms a generally L-shaped member, where each leg has generally the same length. The springs 329 provides the belt drive system with enhanced stabilization and tensioning by compensating for misalignment and belt lengthening. The blade arm 313 and counter arm configuration also facilitates the installation and removal of the drive belt 317 (see FIG. 4) during assembly or servicing, where the user can push the counter arm 315 towards the blade arm 313 to loosen the wrap-around engagement of the drive belt 317 and thereby allow for installation or replacement.

In operation, as depicted in FIGS. 4-5, the user employing the tool energizes the blade driving motor 310 via the control panel 115 (see FIG. 1). As the blade driving motor 310 rotates the drive pulley 312, the drive belt 317 causes the blade pulley 314 to rotate and thereby rotate the blade wheel 113 via the blade shaft 319. In adjusting the height of the blade wheel 113, the user energizes the height adjusting motor 351 via the control panel 115 (see FIG. 1), which in turn, rotates the worm 354 via the intermediate shaft 353. As the worm 354 rotates, the threads of the worm 354 engaged with the teeth of the worm gear 358 will cause the worm gear 358 to rotate. The height adjusting motor 351 is selectively reversible so that the worm 354 can be rotated in either direction. Since the worm gear 358 is fixedly attached to the blade arm 313, the blade arm 313 will rotate in unison with the worm gear 358 and thereby raise or lower the blade wheel 113, depending on the direction of rotation of the height adjusting motor 351.

With the blade driving motor 310 remaining substantially stationary relative to the tilt frame 400, the blade arm 313 and counter arm 315 are configured to turn in unison such that, as shown in FIG. 6A, when the blade wheel 113 is initially in the stowed position, when the user energizes the height adjusting motor 351 to raise the blade wheel 113, the blade arm 313 will rotate in the counter clockwise direction causing the blade wheel 113 to rise. The upward swing motion of the blade arm 313 causes the blade pulley 314 to takes up additional slack in the drive belt 317 extending from the drive pulley 312 towards the blade pulley 314. The counter arm 315 rotates to simultaneously counteract the effects of the blade pulley 314 displacement on the drive belt 317 by giving up slack in the drive belt 317 extending from the drive pulley 312 towards the counter pulley 316.

As shown in FIG. 6B, the blade wheel 113 is raised to its maximum height. In lowering the blade wheel 113, the user energizes the height adjusting motor 351 to rotate the blade arm 313 in the clockwise direction. The downward swing motion of the blade arm 313 causes the blade pulley 314 to give up slack in the drive belt 317 extending from the drive pulley 312 towards the blade pulley 314. The counter arm 315 rotates to simultaneously counteract the effects of the blade pulley 314 displacement on the drive belt 317 by taking up additional slack in the drive belt 317 extending from the drive pulley 312 towards the counter pulley 316.

Referring now to FIG. 7, the tilt frame 400 and its attached elements supporting the blade drive assembly 300, height adjusting device 350, and tilting mechanism 500 will be described in detail. As best shown in FIG. 7, the axle 318 that supports the blade arm 313 and counter arm 315 (see FIG. 5) is fixedly attached to the vertical face of the tilt frame 400 and has a generally horizontal axis perpendicular to the vertical face of the tilt frame 400. A cover plate 411 is fastened to the tilt frame 400 via mounting brackets 410, 417 and has a hole 412 sized to fit the end of the axle 318 to provide support for the free end of the axle 318. The tilt frame 400 further includes a height adjusting motor mounting base 413 fixedly attached to the tilt frame 400 for supporting the height adjusting motor 315. A drive motor mounting base 311 for the blade driving motor 310 is adjustably attached to the tilt frame 400 by fasteners extending horizontally through vertical slots 414 and through plate holes 415. The tilt frame 400 has a curved slotted hole 416 oversized to allow the blade shaft 319 (see FIG. 5) to move in its predetermined range of motion without contacting the tilt frame 400.

A tilting nut coupling plate 510 is pivotally joined to the tilt plate 400 via pivot frames 513 and 514. The pivot frame 513 and 514 have pivot holes 511 and 515, respectively, and are sized to fit pins 512 that are fixedly attached to the coupling base plate 510. The coupling base plate 510 is retained by the pivot frame 513 to the tilt frame 400 by fasteners.

Still referring to the embodiment of FIG. 7, the figure also illustrates the manner in which the tilt frame 400 is mounted on the carriage assembly 212. The tilt frame 400 further includes pins 418 and 419 that are rigidly attached to the top corners of the tilt frame 400. The tilt frame 400 is pivotably mounted on the lower part of the pivot blocks 214L and 215L and retained by the upper part of the pivot blocks 214U and 215U, respectively.

Referring now to FIGS. 8A and 8B, the tilting mechanism 500 is shown. The tilting mechanism 500 includes a tilting motor 516, a tilting motor mounting plate 517 rigidly attached to the vertical support plate 222, an intermediate shaft 518 coupled to a output shaft 519 of the tilting motor 516, shaft support mounts 520 for supporting the intermediate shaft 518, a universal joint 521 coupling the intermediate shaft 518 and a tilting threaded rod 522, and a tilting nut 523 fastened to tilting nut coupling plate 510 and threadbly engaged with the tilting threaded rod 522. The tilting mechanism 500 is used to tilt the tilt frame 400 between a nominal operating position, where the tilt plate is generally parallel to the vertical direction 154, shown in FIG. 8A, and at least a forty five degree position away from its nominal operating position, shown in FIG. 8B.

In operation, the tilting motor 516 rotates the tilting threaded rod 522, which in turn, translates the tilting nut 523 along the axis of the tilting threaded rod 522. The tilting motor 516 is selectively reversible so that the tilting threaded rod 522 can be rotated in either direction. The tilting nut 523 is coupled to the tilting nut coupling plate 510, which is pivotally mounted to the tilt frame 400. When the tilting threaded rod 522 rotates, the tilting nut 523 applies a push or a pull on the tilt frame 400 to rotate about its pivot axis, depending on the direction of rotation of the tilting motor 516.

The universal joint 521 and the tilting nut coupling plate 510 are configured to allow the tilting threaded rod 522 axis to gradually incline as the tilt frame 400 rotates away from it nominal operating position and to gradually recline as the tilt frame 400 rotates towards its nominal operating position. The tilting threaded rod 522 and tilting nut 523 acts like a jack screw; so when the tiling motor 516 is in stop, it holds the tilt frame 400 firmly in position.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

The embodiments of the invention in which an exclusive property or privilege is claimed are defined as follows:

1. A traversing mechanism of a table saw, wherein the table saw comprises a) a main frame assembly; b) a work-piece support platform mounted to said main frame and having a saw slot and a saw slot axis; c) a blade driving mechanism mounted to a tilt frame, said tilt frame mounted to and traversable by said traversing mechanism, said blade driving mechanism comprising a drive motor for driving the blade wheel which is translatable through said saw slot to cut a work-piece on said work-piece support platform; said traversing mechanism comprising: (i) a linear guide assembly disposed under the work-piece support platform and fixedly mounted to said main frame assembly; (ii) a carriage assembly slidably mounted on said linear guide assembly, slidable on a linear path generally parallel to said saw slot axis, said tilt frame is coupled to said carriage assembly and pivotable about an axis parallel to said saw slot axis; (iii) a threaded rod actuator having opposing front and rear ends mounted to said main frame, configured to move said carriage along said linear guide assembly.

2. The traversing mechanism according to claim 1, wherein the threaded rod is coupled to and driven by a motor.

3. The traversing mechanism according to claim 2, wherein said motor is controlled via a control panel.

4. The traversing mechanism according to claim 1, wherein the carriage is spaced apart from the main frame during its translation in its predetermined range of motion.

5. A traversing mechanism of a table saw, wherein the table saw comprises a) a main frame assembly; b) a work-piece support platform mounted to said main frame and having a saw slot and a saw slot axis; c) a blade driving mechanism mounted to a tilt frame, said tilt frame mounted to and traversable by said traversing mechanism, said blade driving mechanism comprising a drive motor for driving the blade wheel which is translatable through said saw slot to cut a work-piece on said work-piece support platform; said traversing mechanism comprising: (i) a linear guide assembly disposed under the work-piece support platform and fixedly mounted to said main frame assembly; (ii) a carriage assembly slidably mounted on said linear guide assembly, slidable on a linear path generally parallel to said saw slot axis, said tilt frame is coupled to said carriage assembly and pivotable about an axis parallel to said saw slot axis; (iii) a threaded rod actuator having opposing front and rear ends mounted to said main frame, configured to move said carriage along said linear guide assembly.

6. The traversing mechanism according to claim 5, wherein the threaded rod is coupled to and driven manually via a hand crank.

7. The traversing mechanism according to claim 5, wherein the carriage is spaced apart from the main frame during its translation in its predetermined range of motion.

8. A traversing mechanism of a table saw, wherein the table saw comprises a) a main frame assembly; b) a work-piece support platform mounted to said main frame and having a saw slot and a saw slot axis; c) a blade driving mechanism mounted to a tilt frame, said tilt frame mounted to and traversable by said traversing mechanism, said blade driving mechanism comprising a drive motor for driving the blade wheel which is translatable through said saw slot to cut a work-piece on said work-piece support platform; said traversing mechanism comprising: (i) a linear guide assembly disposed under the work-piece support platform and fixedly mounted to said main frame assembly; (ii) a carriage assembly slidably mounted on said linear guide assembly, slidable on a linear path generally parallel to said saw slot axis, said tilt frame is coupled to said carriage assembly and pivotable about an axis parallel to said saw slot axis; (iii) a first actuator and second actuator each comprising a threaded rod having opposing front and rear ends mounted to said main frame, configured to move said carriage along said linear guide assembly.

9. The traversing mechanism according to claim 8, wherein the first actuator and second actuator is coupled to and driven by a motor.

10. The traversing mechanism according to claim 8, wherein said motor is controlled via a control panel.

11. The traversing mechanism according to claim 8, wherein the carriage is spaced apart from the main frame during its translation in its predetermined range of motion.
